(19) United States
(12) Patent Application Publication
(10) Pub. No.: US 2007/0192115 A1
(43) Pub. Date: Aug. 16, 2007

(54) Method for initiating a real estate transaction

(76) Inventor: Christopher G. Oliver, Houston, TX (US)

Correspondence Address: LAW OFFICE OF DAVID MCEWING, P.O. BOX 231324, HOUSTON, TX, 77023, US

(21) Appl. No.: 11/351,428

(22) Filed: Feb. 11, 2006

(51) Int. Cl. G06Q 99/00

(52) U.S. Cl. 705/1

(57) ABSTRACT

The invention teaches a method of initiating communication between a purchaser and an owner of property not advertised or publicly offered for sale. The method includes the steps of the purchaser identifying a target property to a website portal utilizing the Internet and the website portal initiating a property inquiry to a property owner. The property inquiry includes an Internet address for response. The invention further teaches a method of initiating communication between a purchaser and a property owner comprising the steps of a purchaser identifying a target property to website portal utilizing the Internet, the website portal collecting and communicating target property information to the purchaser and the website initiating a property inquiry to a property owner with an Internet address for the property owner to communicate a response. The invention further comprises a real estate transaction system comprising a website wherein a prospective purchaser can identify property, receive information concerning the property, can initiate communication to the property owner and receive a property owner response.

### 1. FIELD OF USE

The invention includes a method for initiating negotiations for the purchase and sale of real estate that is not advertised or publicly offered for sale. The invention further provides a means of communicating at least the initial steps of such negotiation.

### 2. BACKGROUND OF INVENTION

There have been several suggested methods for utilizing the Internet in conjunction with the purchase and sale of real estate.

### SUMMARY OF INVENTION

The invention teaches a method of initiating communication between a purchaser and a property owner regarding property not advertised or publicly offered for sale. The method includes the steps of the purchaser identifying a target property to a website utilizing the Internet and the website initiating a property inquiry to a property owner. The property inquiry includes an Internet address for response. The invention further teaches a method of initiating communication between a purchaser and a property owner comprising the steps of a purchaser identifying a target property to a website portal utilizing the Internet, the website portal collecting and communicating target property information to the purchaser and the website initiating a property inquiry to a property owner with an Internet address for the property owner to communicate a response. The invention further comprises a real estate transaction system comprising a website wherein a prospective purchaser can identify property, receive information concerning the property, can initiate communication to the property owner and receive a property owner response.

A more complete understanding of the present invention, as well as further features and advantages of the present invention, will be obtained by reference to the following detailed description and drawings.

### SUMMARY OF DRAWINGS

FIG. 1 illustrates an embodiment of the invention wherein the purchaser communicates through the Internet to the website portal and acquiring information from Internet accessible databases concerning a property of interest. A property inquiry may be communicated from the website to the property owner though means other than the Internet. Also illustrated is a response of the property owner being communicated to through the Internet to the website.

FIG. 2 illustrates an embodiment of the invention wherein the website serves as a portal accessing information or databases concerning properties and communicating information among the purchaser, the property owner and the website sponsor. An initial property inquiry is illustrated as being communicated to the property owner by means other than the Internet.

FIG. 3 illustrates an embodiment of the invention wherein the website portal accesses multiple databases. Information or data may be acquired in response to search engine inquiries and responsive data communicated back to the website. The collected data may be categorized or otherwise organized by the software and services of the website and communicated to the purchaser.

FIG. 4 illustrates an example of a fee compensation arrangement for a payment to the website from the purchaser and property owner.

FIG. 5 illustrates another example of a fee compensation arrangement wherein the fee is shown to be paid directly to the website sponsor. Information or data may be communicated between the property owner and purchaser via the website.

FIG. 6 illustrates one embodiment of the invention beginning with a purchaser logging into the website subject of the invention.

FIG. 7 illustrates one embodiment of a data tracking process that may be requested by a purchaser as part of the invention. Internet accessible databases may be searched for data pertaining to target property.

### DETAILED DESCRIPTION OF THE INVENTION

The invention includes a method for initiating negotiation for the purchase and sale of real estate (hereinafter “property”) not advertised or publicly offered for sale. Property advertised or publicly offered for sale includes property subject of a real estate agency listing agreement for sale. Through the website subject of the invention, a prospective purchaser can inquire whether the owner is interested in selling the property. The invention further provides a means of communicating at least the initial steps of such negotiation. Concurrent with initiating a property inquiry that invites a response from a property owner, the invention provides a portal wherein ancillary services may be offered and information may be accessed and communicated to the prospective buyer.

The method of the present invention comprises multiple steps. A potential purchaser or buyer (“purchaser”) identifies real estate of interest (hereinafter “target property” or “property of interest”) for possible purchase. The purchaser communicates the identity of the target property through the Internet (utilizing a browser) to a website comprised of one or more web pages and typically written in HTML or similar (hereinafter “website”). The browser typically translates the HTML encoded files of the website into text, images, sounds, etc. Examples of browsers include Microsoft Internet Explorer and Netscape Navigator.

The website may comprise or constitute a portal, that being a website that aggregates content of the World Wide Web (hereinafter “web”) accessible at other websites and provides services such as a search engine and email. A search engine includes software (e.g. spider or web crawler) and database architecture that allows the purchaser to search the web. Examples of search engines include Google or Yahoo. The search engine can include services which allow a user to search the websites that contain certain categories of information or to search for key words. Aggregation of web content includes the steps of searching and retrieving (collecting) data.

The Internet website is accessed by a web browser through one or more HTTP servers. The website may also incorporate means of communication such as email or instant messaging. Communication can be implemented through various devices such as but not limited to PCs, wireless communication handheld devices such personal data assistance (PDAs), and telephones having access to the Internet or other network.

As used herein, the Internet comprises a network of interconnected computers utilizing TCP/IP protocols and that may be interconnected with innumerable smaller groups of linked computers thereby constituting a network of networks, or by other means (hereinafter collectively termed the “Internet”) and can include or incorporate intranets, local area networks, and wide area networks. The Internet transfers email and web content.

The website may be hosted or sponsored by an entity (hereinafter “sponsor”). The sponsor operates the website. In one embodiment, the sponsor may be licensed or authorized to represent buyers or sellers in the purchase and sale of real estate. For example, the website may be hosted by an attorney or by a real estate agent. It may, in another embodiment, be hosted or sponsored by a group or association of real estate agents. It may also be sponsored by an entity operating one or more search engines or browsers. In another embodiment, the sponsor may be a vendor or provider of ancillary services such as title services, mortgages or mortgage brokers, home inspectors etc.

In an additional step of the method, the prospective purchase can receive information regarding the target property (“target property information”) through the website. This information may include the name of the owner of the property. It may include whether the target property is currently offered for sale. This information can include whether the target property is advertised or publicly offered for sale either “by owner” or is subject of an agency agreement of a real estate broker listing the property for sale (a real estate agency listing agreement).

Information available to the prospective purchaser via the website may also include the real estate tax information, title information such as recorded liens or mortgages, past real estate purchase and sales, zoning or deed restrictions, easements, or information of other property of the owner, physical property information, and information regarding the owner such as bankruptcy or litigation, etc. Information regarding the target property such as year the house was built, number of bedrooms and bathrooms, pool, land area, or other structures or improvements, etc. (hereinafter “physical property information”) may also be obtained.

Information can be searched for and collected by the website through searching of other Internet accessible databases, e.g., locating previously unknown data within existing databases. Such databases may include real estate multiple listing services (“MLS”), registry of deeds or county clerk records, school districts, tax assessor and/or tax collector records, appraisal districts, etc. Other examples may include flood control districts, utility service providers, and public safety (including but not limited to police and fire). Traffic information can be collected.

It will be appreciated that such information and databases are not limited to government records but can include commercial databases such as newspapers, newspaper archives, Internet mapping services, satellite photo retrieval or indexing services, coverage or proximity to hospital and health care related services, high speed or wireless internet access providers, etc. Any database accessible by a search engine can be accessed. Information can also be acquired by other means including manual accessing and data entry. This task or function may be performed by the website sponsor.

Information can be acquired regarding the target property as well as abutting or neighboring property. Information can also be acquired on property having similar characteristics. These “similar characteristics” can be defined by the purchaser.

It will be appreciated that property can be also identified by consideration of other factors that may be subject of the data collection taught be the present invention. For example, prospective purchasers of property may be concerned with schools, traffic, crime and innumerable other variables. Families looking to purchase a new home frequently ask “is it a good neighborhood?”, “are there good schools?”, “is the house on a busy street?”. For purpose of illustration, consideration of these three identified variables (schools districts, traffic counts and crime statistics) may result in certain locations to be preferable to other locations. Specific sections of neighborhoods can be identified having the optimum characteristics. Armed with this information, the purchasers can identify specific properties that can be selected for additional information and/or submission of an inquiry to the property owner(s) concerning interest in selling (hereinafter “property inquiry”).

The website may offer other services relevant to the sale or lease of real estate such as real estate agency services, real estate appraisers, on-line property valuation services, title insurance companies, mortgages or mortgage brokers, surveyors, attorneys, etc., (hereinafter “ancillary services”). An example of an on-line valuation service is zillow.com of Seattle Wash., and wherein a property address can be submitted to a website and valuation of the property returned by the website through the Internet.

In one embodiment of the invention, the prospective buyer (“purchaser”) identifies a property that appears to meet the purchaser's criteria for a new home. It may be that the target property is particularly aesthetically appealing to the purchaser. There may be other factors that have distinguished the target property. In any event, the first step of the method can be that the purchaser may have a street address for a property of interest.

The purchaser visits the website of the invention. The purchaser may request additional information regarding the target property. For example, the purchaser's first inquiry may be whether the target property is currently advertised or publicly listed for sale. The purchaser may inquire of the selling or listing price of other property within the vicinity of the property of interest. Other information may be solicited or received. The purchaser may inquire of the identity and address of the owner of the property of interest.

As an additional step of the method, if the property is not advertised or publicly listed (e.g., through a real estate agency listing agreement) or offered for sale, the purchaser may request that a property inquiry be submitted to the owner. The owner of property of interest and not advertised or publicly offered for sale or listed for sale (as may be disclosed in a search of a multiple listing service or “MLS”) is hereinafter termed the “property owner”. The purchaser can, through the website, submit an inquiry (“property inquiry”) to the property owner. This property inquiry can be limited to a message to the effect “Are you interested in selling your property?”. It may be expanded to a message to the effect “Are you interested in selling your property for $250,000.00?”. or “Are you interested in selling your house between $150,000.00 and $200,000.00?”. Presumably, mention of a specific price or price range would be at least in an amount approximate to an estimated market value of the target property based upon recent comparable sales of similar property in the vicinity or a property valuation service.

In one embodiment, the property inquiry is submitted to the property owner without identifying the purchaser. The property inquiry may identify the sponsor of the website through which the purchaser is communicating the property inquiry. The property inquiry includes an address or other identifier allowing the property owner to communicate a response to the property inquiry. An example of an identifier may be an Internet address. It may be an email address or it may be a website.

In an embodiment of the invention, the property inquiry may include information that, while not identifying the purchaser, may evidence that the purchaser is qualified or competent to enter into a binding agreement for the purchase and sale of the target property at a purchase price approximate to market value of the property. This information, hereinafter “qualification information”, may be of various forms or types. In one example, the purchaser may provide a credit score as issued by a credit reporting agency. This may be verified or unverified. For example, the property inquiry can contain a message to the effect that it is being made on behalf of a current home owner have a credit score in excess of 700. The credit score may be verified by a credit score being obtained by or on behalf of the website. Another example can be a representation that the purchaser has deposited a monetary sum that will be held for a stipulated period of time awaiting a response from the property owner. If no response is received or the property owner communicates that he/she is not interested in sale, the deposit will be returned to the purchaser. If, however, the property owner communicates that he/she is prepared to negotiate an agreement of the purchase and sale of the property (hereinafter “sale agreement”), the deposit may continue to be held, for example, in an escrow account of a title company. In another embodiment, the deposit may be conveyed to the property owner upon communicating that the property owner is prepared to negotiate a sale agreement. In another embodiment, the property inquiry may state that the purchaser has paid a nonrefundable price for the property inquiry to be communicated to the property owner. Included within the invention are other embodiments that communicate to the property owner that a qualified and competent purchaser exists that is interested in initiating negotiation of a sale agreement.

As indicated the property owner is not currently marketing the target property for sale. For example, the target property may not be currently subject of a real estate agency listing agreement wherein the property owner has agreed to pay a commission to a third party in the event a conforming offer is received from a buyer. The invention includes a method for initiating negotiation for the purchase and sale of property not currently offered for sale. The invention further includes communicating at least the initial steps of such negotiation through the website. Concurrent with initiating a property inquiry that invites a response from a property owner, the invention may provide a portal wherein ancillary services may be offered and other databases may be searched.

In one embodiment, the property inquiry may constitute a binding offer for purchase that, upon acceptance by the property owner, creates a sale agreement for the target property. In other embodiments, the property inquiry is an expression of interest and invitation to the property owner to commence negotiations or discussions that may result in a sale agreement for the target property. In as much as laws and regulations exist in many localities that govern the purchase and sale of real estate (“property), the method of the invention contemplates and comprehends additional steps required to conform with such laws and regulations.

It will be appreciated that initiation of a property inquiry may first require the purchaser to expressly consent to certain terms and conditions of use that may be posted upon the website. As applicable, such terms and conditions may stipulate that a property inquiry does not constitute an offer for the purchase of the target property. Further, and as applicable, the terms and conditions of use may stipulate that the website or website sponsor is not acting as agent for either the purchaser or for the property owner. In other instances, an agency or other relationship may be created between the purchaser and the website sponsor. For example, the website may be sponsored by an attorney or real estate agent.

The terms and conditions of use may include agreement for payment of compensation, whether as commissions or otherwise, by the purchaser to the website sponsor. Such fee may vary in that there may be various levels of services performed by the website sponsor or others. In one embodiment, the purchaser may pay a stipulated fee for the sponsor to communicate the property inquiry to the property owner. This fee may be paid regardless of whether the property inquiry is actually received by the property owner or whether the property owner issues any communication in response.

Fees may also be paid to the website sponsor by ancillary service providers that advertise at the website or that are accessed or employed through the website.

The terms and conditions of use may further include that the website or sponsor is not responsible for errors or lapses in communication. For example, the property inquiry may be communicated to the property owner by regular postal mail to an address listed in public records such as tax assessor records or records of an appraisal district. In other instances the property inquiry may be communicated to a property owner by regular postal mail to an address provided by the purchaser. It may be communicated by telephone or in person. In yet another embodiment, the property inquiry may be communicated electronically to an Internet address such as email or a website address.

In the method taught by the invention, a property inquiry will be sent to the property owner. As indicated, the property inquiry may be transmitted by regular postal mail. This task may be performed by the website sponsor and may utilize documents created electronically from the website. In this manner the website initiates the property inquiry at the request of the purchaser. In this example the property inquiry is not communicated to the property owner by the Internet.

The property inquiry may communicate that a qualified and competent purchaser exists that is interested in commencing negotiation with the property owner regarding the sale of the target property. The property owner is invited to visit or email the sponsored website. It is through the website that the property owner can follow-up or respond to the property inquiry. The sponsored website or page of the website may be specific to the target property. It may include information regarding the property that may not be readily accessible to the property owner. In addition, it may include information regarding other recent sales of neighboring property, thereby providing the property owner with an ability to evaluate the property inquiry, particularly if the property inquiry includes a price range at which the purchaser proposes to initiate negotiations.

The website may provide additional information (qualification information) accessible to the property owner regarding the purchaser. It may include the identity of the purchaser. It may also include contact information for the purchaser. The property owner may be charged a fee to obtain this information. This information can include whether the purchaser is an existing property owner, whether the purchaser is located within the area in contrast to “relocating”, whether the purchaser has pending property inquiries for other properties, etc.

The website may advertise other services of the sponsor. The website may also advertise ancillary services.

The website may also require the property owner to agree to or accept terms and conditions of use. For example, the property owner may be required to agree that the website sponsor is not making representations or warranties upon which the property owner is relying concerning either the target property, information or records purported to pertain to the target property (such as information acquired from sources such as tax records, etc.), accuracy of comparable property sales, or accuracy of information regarding or supplied by the purchaser, etc. The terms and conditions of use may further require that the property owner acknowledge that the website sponsor is not acting as an agent or representative of the property owner or that the property owner acknowledges that the website sponsor is acting as the agent of the purchaser, etc.

The property owner may be required to agree that the website sponsor is to be compensated by the property owner upon the happening of stipulated events such as a sale agreement or purchase of the target property by the purchaser.

The property owner, in one embodiment, may be required to pay a fee to the website sponsor in order to access information regarding the purchaser, the target property or to send a communication to the purchaser. Such a communication may be affirmation of the property owner's interest in initiating negotiations concerning the purchase of the target property.

It will be appreciated that in one embodiment of the invention, once the purchaser and property owner agree to the terms and conditions of use of the website sponsor, the purchaser and property owner may communicate directly and independently of the website. In another embodiment, direct communication may be achieved only after one or more fees have been paid.

In another embodiment of the invention, the events relevant to the target property, possibly including events pertaining to the property owner, may be tracked for the benefit of the purchaser. This “data tracking” function can be performed by the website and notice provided to the purchaser. This tracking of information relevant to the target property can be through Internet accessible databases. Information can include a future listing of the target property for sale. Therefore the purchaser can maintain awareness of future developments concerning the property regardless of the property owner's response (or non response) to the property inquiry. Utilizing the web portal functions of the website, the purchaser can be learn of developments relevant to the property from various sources such as bankruptcy filings, tax delinquencies, or similar. Developments can also include sales of neighboring property. This service may be subject of additional fees to the website.

In another embodiment of the invention, the purchaser may be informed of other property having the same characteristics of the target property. These “similar properties” can be selected based upon the purchaser's identified criteria of interest. For example, if the purchaser has inputted search criteria based upon schools, traffic and crime, properties within the same school district with low traffic and crime may be displayed.

The website subject of the invention can be comprised of a variety of components as will be appreciated by persons skilled in the art. Components may include CPUs for executing commands, memory for temporarily holding information and instructions, storage memory which stores information and software applications, operating system for coordinating between the various components and software applications, hardware drivers that allow the operating system to communicate with physical elements of the website (or server) such as input devices (mouse, keyboard, microphone, etc.), network adaptor for communicating over the Internet, input devices and display. It may also comprise multiple databases, as well as search engine software. The website subject of the invention may also comprise a server, being a computer running software such as Apache, Microsoft Internet Information Server, or Netscape Enterprise Server, and assigned an IP address and connected to the Internet so that it can provide documents via the web. A server is a computer or software package that provides a specific kind of service to a client software running on different computers. An example can be an IBM RISC System/6000 computer running the AIX (Advanced Interactive Executive Version 4.1 and above) Operating System and a web server program e.g. Netscape Enterprise, etc. The system subject of the invention may utilize database software such as Oracle 8i to create or manage the various databases utilized or maintained by the system.

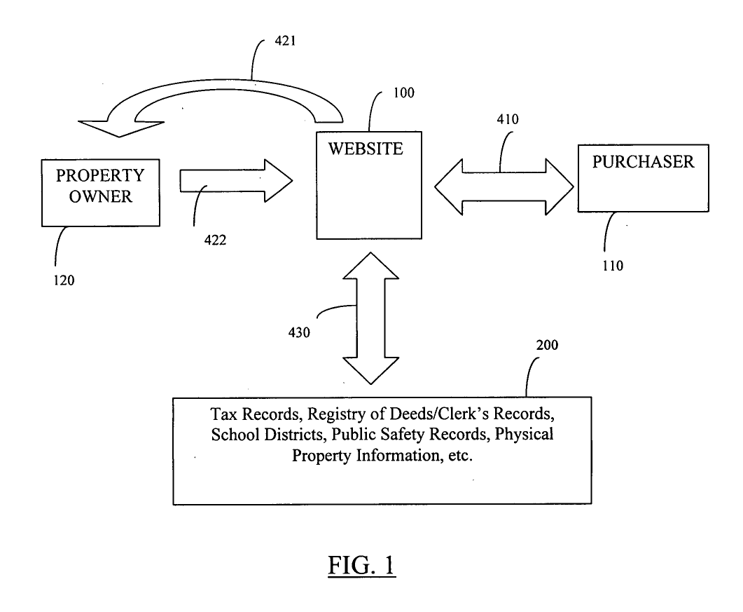

FIG. 1 illustrates an embodiment of the invention. The purchaser 110 is illustrated to be in communication with website 100 via the Internet 410. Through this connection, and responsive to a data request of the purchaser, the search engine of the website searches 430 Internet accessible databases 200 such as tax records, etc. Responsive information may be collected 430 and organized by the website and communicated back 410 to the purchaser. Through the website, the purchaser may also request a property inquiry 421 be initiated for communication to the property owner. The property owner may respond 422 to the property inquiry via the Internet to the website.

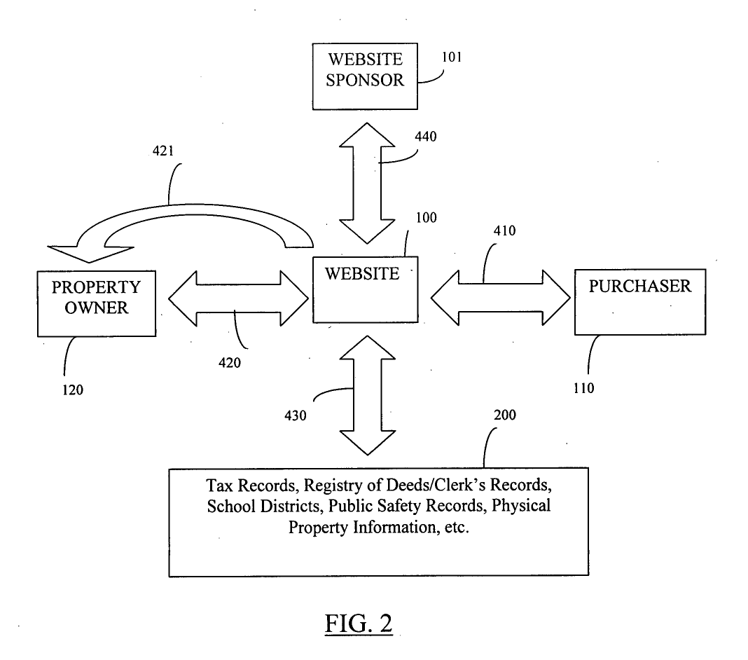

FIG. 2 illustrates the website serving as a portal (as also shown in FIG. 1) but further illustrating communication 410, 420, 440 among the purchaser 110, property owner 120 and website sponsor 101. The website 100 serves as a portal to various Internet 430 accessible databases 200 such as tax records, county clerk's office and/or registry of deeds, school district information and public safety (police reports), etc.

As in FIG. 1, the method may begin with a purchaser 110 utilizing an Internet connection 410 to access the website 100 for information. In response to the purchaser's request for information, the website search engine collects and assembles information. For example, the website may have a data template that can be auto-populated with information collected from differing databases, such as school information, utility districts, property lot size, building size and age, etc. As used herein, “auto-populate” refers to a process where information from a data source is selected and imported into a different data file without the need for additional intervention or instructions from a user. The collected information may then be communicated to the purchaser utilizing the same or differing Internet connection 410.

The communication with the website sponsor may include acceptance of the terms and conditions of use. These terms and conditions may govern the relationship or responsibilities (or absence of such responsibilities) between the purchaser and website sponsor and between the property owner and website sponsor.

Concurrent with the initial information request of the purchaser or independent of any such request, a property inquiry 421 may be initiated through the website to the property owner. This property inquiry may be submitted by means other than the Internet connection inasmuch as an Internet address, e.g., email address, may not exist or be known to the website or purchaser. However, a response from the property owner may be communicated 420 through the Internet to the purchaser (and to the website sponsor). The owner's response (if any) may be communicated to the website or to another site controlled by the website sponsor.

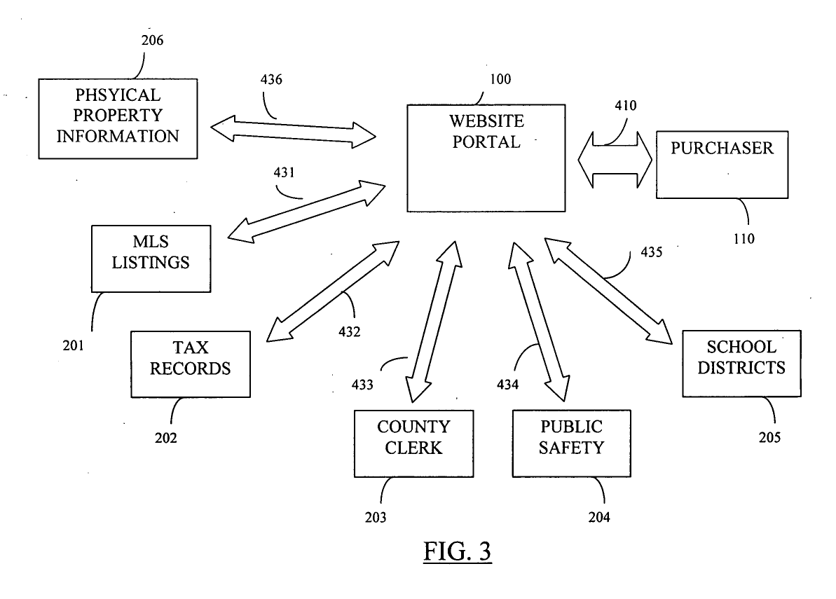

FIG. 3 illustrates the Internet portal function wherein the website aggregates Internet accessible information for communication to the purchaser. The purchaser 110 in one embodiment communicates 410 the identity of a target property to the website portal 100. The portal searches multiple databases 201, 202, 203, 204, 205, 206 for information regarding the target property. These searches and search results are conducted 431, 432, 433, 434, 435, 436 through the Internet and communicated 410 to the purchaser through the portal 100. It will be appreciated that the illustrated databases are examples and other databases, including commercially operated databases, may be accessed.

In another embodiment, the purchaser may communicate criteria for a property or properties. The portal may search one or more databases for property that may fit the communicated criteria. In another embodiment, a separate website may be created specific to the target property. This website may be accessed directly through the Internet. The property owner may be directed to this website via the Internet address contained in the property inquiry. Access to the site may be password controlled, thereby restricting access to the property owner and purchaser.

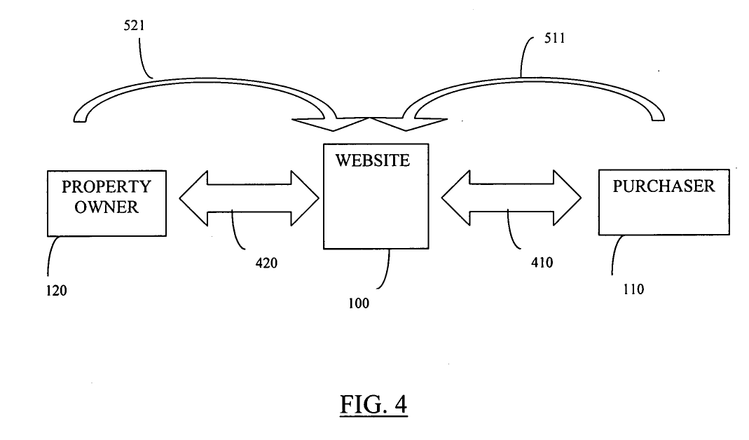

FIG. 4 illustrates an embodiment wherein communications 410, 420 between the purchaser 110 and the property owner 120 are conducted through the website 100. In addition an optional fee compensation 511, 521 relationship is illustrated. Although fees may also be conveyed through electronic fund transfers through the Internet, it may be desirable to use other means. The website sponsor may be compensated by the purchaser for the search and aggregation of information regarding the target property and/or for communicating (optionally anonymously) a property inquiry. This fee compensation strategy may include content relative to the qualification or competency of the purchaser made to the property owner. The property owner may compensate the website sponsor through a fee payment 521 for having provided access to a purchaser for the target property. The fee may be paid by the property owner to enable the property owner to access the purchaser, either through the website or otherwise. It will be appreciated that the compensation payable to the website sponsor may be in addition to commissions paid to real estate agents or other representatives or agents of either the purchaser or seller. It may also be in addition to other fees paid for services such as appraisals, inspections, etc.

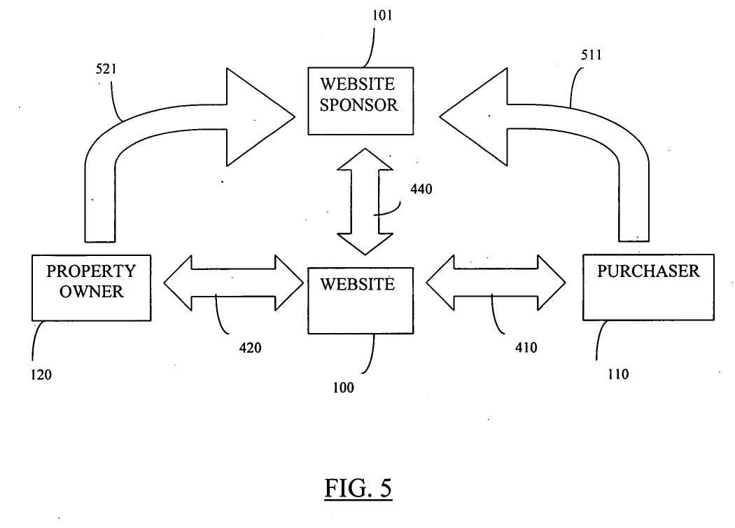

FIG. 5 illustrates communication 521, 511, e.g., payment of fees, from the property owner 120 and purchaser 110 directly to a website sponsor 101. This is in addition to communication 410, 420 between the property owner and purchaser through the website. Communication 440 through the website can include communication with the website sponsor.

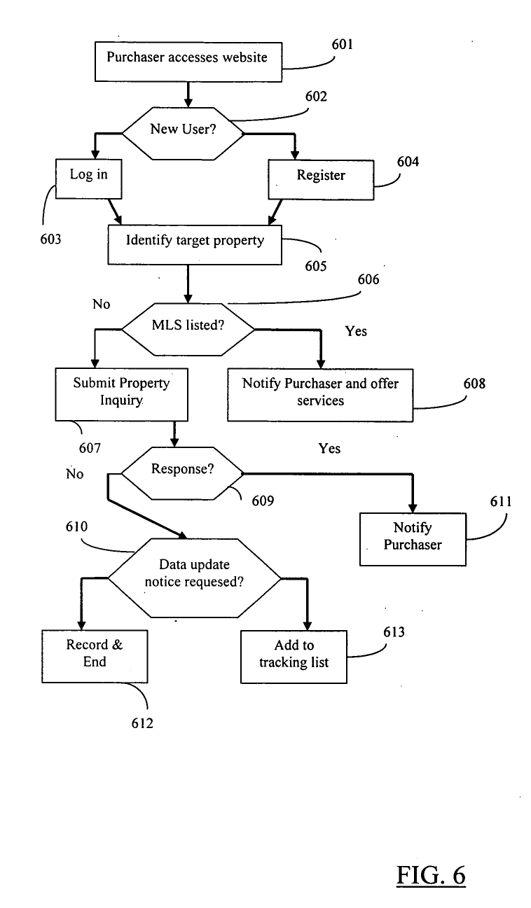

FIG. 6 illustrates one embodiment of the invention. The process begins with a purchaser accessing the website via the Internet 601. The website inquires 602 if the purchaser is a first time visitor to the site. If a previous user, the purchaser may be asked to log in 603. This step may require entering variously a user name, an email address and/or a password. Other information may be requested.

If the purchaser is a first time user, then the purchaser may be requested to register 604. Registration may include entry of an email address, selection of a password or user name. The registration step may also include the purchaser accepting the website terms and conditions, including agreement of the relationship between the website sponsor and the purchaser. It may also include agreement to compensation or fee payment provisions. The purchaser may also furnish information regarding current home ownership, financing qualification or similar information. This information may include certification or representations that may be communicated to a property owner as part of a property inquiry. This may include a credit rating score such as issued by Experian, Trans Union or Equifax. This information may be used by the website to assess the qualification or “competency” of the purchaser to enter a sales agreement for a target property. This assessment may be communicated as part of the property inquiry.

The purchaser identifies the target property 605 intended to be subject of a property inquiry. There also may be a fee payment step. Optionally, the website may inquire 606 via its search engine or database whether the property identified is already listed for sale. This step may include whether the property owner is represented by a real estate agent. If the target property is listed for sale, the purchaser may be offered 608 other services, including if the purchaser wants representation by a real estate agent or attorney.

In the embodiment of the invention illustrated, a property inquiry is submitted 607 to the property owner disclosed in the website database or through the search of web content. Through the website, an event (or non event) of a response is tracked 609. If, after a specified period of time a response is not received, the purchaser is notified of “no response”. The purchaser is asked 610 if he/she wants to be informed of changes or events pertaining to the property or the property owner, i.e., “data tracking notice requested?”. If the purchaser declines, information specific to the purchaser and the property inquiry is stored through the website 612. If the purchaser elects to have the property tracked 613, the system is appropriately activated.

If a response to the property inquiry is received, the purchaser is notified 611. If the response indicates a willingness or interest of the property owner to negotiate a sale agreement, the purchaser and property owner can conduct further communication either through the website or by other means including the Internet.

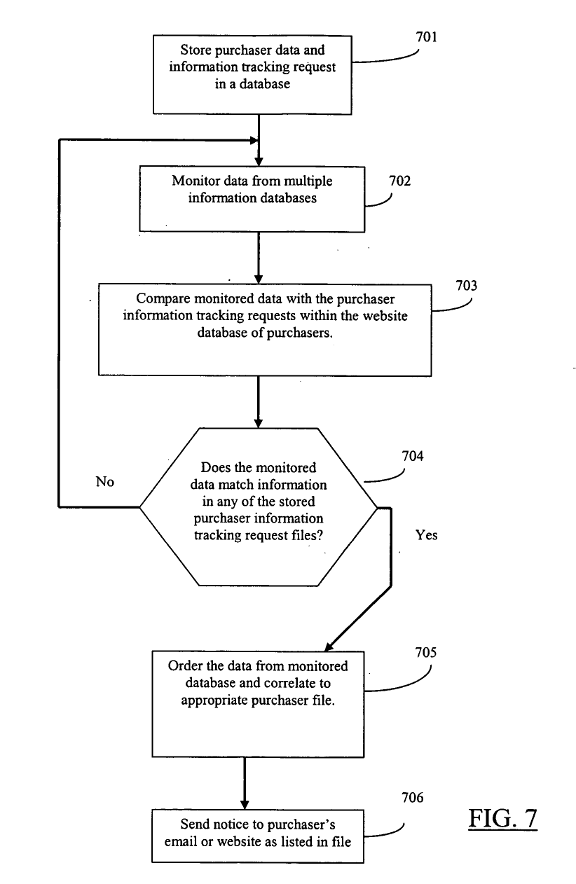

FIG. 7 illustrates the property tracking component of the invention wherein a purchaser elects to have the target property “tracked”. The property information tracking request is recorded 701 along with the purchaser's data (including email address or website). Selected databases are monitored or updated 702. The number or type of database to be monitored may be selected by the purchaser and varying fees may be charged to the purchaser dependent upon the number or type of databases selected. These may be the same databases which are searched by the search engine in response to other purchaser contacts to the website regarding other properties. It will be appreciated that most of these databases are Internet accessible. Information within the databases are compared with the properties subject of information tracking requests 703. In one embodiment, a new database entry (such as a new property valuation within a tax appraisal district database) is correlated to a property identity and the property is compared to properties subject of information tracking requests 704. If the property is matched to the website database of a property tracking request, the new database entry may be downloaded to the website database 705 and the purchaser is notified 706. For example, the purchaser may receive an email from the website stating: “The property at 123 Main Street, Anytown has been reappraised. The new appraisal value is $150,000”. In another example, the purchaser may receive an email stating: “A lien has been filed by the City of Anytown for unpaid property taxes on the property at 456 Smith Street, Anytown”.

It is to be understood that the embodiments and variations shown and described herein are merely illustrative of the principles of this invention and that various modifications may be implemented by those skilled in the art without departing from the scope and spirit of the invention. In as much as laws and regulations exist in many localities that govern the purchase and sale of real estate (“property), the method of the invention contemplates and comprehends additional steps required to conform with such laws and regulations.

1-17. (canceled)

18. A method of a website initiating communication with a property owner regarding the purchase of property not offered for sale comprising the steps of:
a. a purchaser identifying a target property that is not offered for sale and communicating the property to a website in communication with a computer network;
b. the website initiating a property inquiry to an owner of the target property wherein the property inquiry informs the owner there is an undisclosed entity interested in purchasing the property and asking whether the owner is interested is selling the property; and
c. the property inquiry including an address or identifier for a property owner response and wherein the response can be matched to the property inquiry.

19. The method of claim 18 further comprising the purchaser paying a fee for the property inquiry to be initiated to the owner.

20. The method of claim 18 wherein the property inquiry includes information demonstrating the purchaser is qualified to purchase the target property.

21. The method of claim 18 wherein the property inquiry includes a purchase price.

22. The method of claim 18 wherein the property owner pays a fee as part of the owner's response to the property inquiry.

23. The method of claim 18 wherein the website further comprises a website portal that communicates information regarding the target property through a computer network.

24. The method of claim 23 wherein the website portal communicates information regarding at least one other property.

25. The method of claim 18 wherein the website portal monitors Internet accessible databases for updated information concerning the target property.

26. A method of a website initiating communication with a property owner comprising the steps of
a. a purchaser identifying a target property to a website portal utilizing the Internet wherein the target property is not offered for sale; and
b. the website initiating a property inquiry to a property owner wherein the purchaser is not disclosed and the property owner is asked if the property owner is interested in selling the target property and the property inquiry includes an Internet address for the property owner to communicate a response.

27. The method of claim 26 further comprising the website portal collecting and communicating target property information to the purchaser utilizing the Internet.

28. The method of claim 26 further comprising the purchaser paying a fee.

29. The method of claim 26 further comprising the property inquiry including a purchase price.

30. The method of claim 26 further comprising the purchaser submitting the target property address to a website via the Internet and receiving a valuation of the property from the website.

31. The method of claim 26 further comprising the property owner paying a fee to the website to respond to the property inquiry.

32. A real estate transaction system comprising a website connected to a computer network and through which a purchaser can identify target property, receive information concerning the target property including information that the target property is not offered for sale, anonymously initiate an inquiry to the owner of the target property and create an Internet or postal address for receipt of an owner response.

33. The real estate transaction system of claim 32 wherein the purchaser can submit a property address to a website via the Internet and receive a valuation of the property from the website.

34. A method of initiating communication to a property owner regarding property not offered for sale comprising the steps of:
a) providing a website hosted by at least one server in communication with a computer network;
b) the website receiving an address of a target property;
c) the website sending an inquiry to an owner of the target property not offered for sale asking if the owner is interested is selling the target property.

35. The method of claim 34 further comprising the message from the website containing an identifier or address for the owner's response.

36. The method of claim 34 wherein the website is used to determine the target property is not offered for sale.

37. An apparatus comprising at least one server component having an interface for communicating over a computer network:
a) a mechanism for transmitting and receiving electronic data input to or from remote computers or servers;
b) a database to store information;
c) a CPU and application program for processing inputted data and generating communications to at least one other database accessible on a computer network concerning properties offered for sale wherein the CPU can evaluate the database and determine that a target property is not for sale; and
d) the CPU and application program generating an inquiry to an owner of the target property not offered for sale regarding whether the owner is interested in selling the target property.
